(19) United States
(12) Patent Application Publication
(10) Pub. No.: US 2011/0186525 A1
(43) Pub. Date: Aug. 4, 2011

(54) TREATMENT OF RECOVERED WELLBORE FLUIDS

(75) Inventor: Rahul Dixit, Houston, TX (US)

(73) Assignee: M-I L.L.C., Houston, TX (US)

(21) Appl. No.: 13/122,493

(22) PCT Filed: Oct. 8, 2009
(86) PCT No.: PCT/US09/59978

§ 371 Date: Apr. 4, 2011

Related U.S. Application Data
(62) Division of application No. 61/104,944, filed on Oct. 13, 2008.
Application No. 61/104,944 is a division of application No. 61/153,072, filed on Feb. 17, 2009.

(51) Int. Cl. C02F 1/78; C02F 1/52

(52) U.S. Cl. 210/708; 210/760

(57) ABSTRACT

A process for treating a recovered wellbore fluid, where the process includes contacting an aqueous wellbore fluid with ozone, wherein the aqueous wellbore fluid comprises organic contaminants; and separating the aqueous wellbore fluid into an organic phase and a clarified water phase is disclosed.

### CROSS-REFERENCE TO RELATED APPLICATIONS

This application claims priority under 35 U.S.C. §119 to U.S. Patent Application Nos. 61/104,944, filed on Oct. 13, 2008, and 61/153,072, filed on Feb. 17, 2009, both of which are hereby incorporated by reference in their entirety.

### BACKGROUND OF DISCLOSURE

1. Field of the Disclosure

Embodiments disclosed herein relate generally to methods of treating recovered wellbore fluids. More specifically, embodiments disclosed herein generally relate to methods of treating recovered wellbore fluids and/or aqueous components of recovered wellbore fluids with ozone.

2. Background

When drilling or completing wells in earth formations, various fluids (collectively referred to as wellbore fluids) typically are used in the well for a variety of reasons. Common uses for wellbore fluids include: lubrication and cooling of drill bit cutting surfaces while drilling generally or drilling-in (i.e., drilling in a targeted petroleum bearing formation), transportation of “cuttings” (pieces of formation dislodged by the cutting action of the teeth on a drill bit) to the surface, controlling formation fluid pressure to prevent blowouts, maintaining well stability, suspending solids in the well, minimizing fluid loss into and stabilizing the formation through which the well is being drilled, fracturing the formation in the vicinity of the well, displacing the fluid within the well with another fluid, cleaning the well, testing the well, implacing a packer fluid, abandoning the well or preparing the well for abandonment, and otherwise treating the well or the formation.

During the drilling or completion process, wellbore fluids may be subjected to various contaminants. As the oil industry continues its thrust towards zero discharge in various sectors of the world and the availability of disposal facilities become more restricted for both solid and liquid wastes, one of the major issues confronting operators and vendors today is the large amount of oily waste liquids or “slops” produced during oil and gas drilling operations. Drilling with oil-based muds often generates large quantities of slops which are produced when an oil- or synthetic-based wellbore fluid, such as an invert emulsion drilling fluid, becomes contaminated with water. Such contamination may occur, for example, when the oil- or synthetic-based fluid encounters a water bearing formation, when water is mixed with the fluid on the rig, or during displacement operations when an oil-based fluid is displaced with a water-based fluid. The unusable mud is typically sent to shore for disposal or reconditioning as hydrocarbon contamination renders these streams ineligible for overboard discharge. The volume of slop produced on a daily basis can vary from 100 to 500 bbls depending rig configuration, geographic location and operational practices. For operators, these large volumes of slop result in enormous disposal expenses and a potentially significant environmental issue

Typically, the oil-water ratio (OWR) of an oil-based drilling fluid is in the range 60:40 to 90:10. However, after contamination with water, the slop mud may contain 50 to 90% by volume of loosely emulsified water and 10 to 50% by volume of the original drilling fluid. Slop water cannot be reused downhole as a wellbore fluid because the presence (or increased amount) of water greatly impacts the wellbore fluid's properties, including increased viscosity and decreased emulsion stability. Further, the presence of hydrocarbons renders the slop water ineligible for overboard discharge.

Although these waste streams are generically coined as “slops,” viable treatments depend on the different characteristics of the waste streams. For example “slops” generated by drilling operations are very different from those typically generated by marine engineering operations. Attempts to treat slops from drilling operations using bilge water treatment systems are not usually successful due to the different characteristics of the waste streams. Oil/synthetic/diesel based drilling fluids are generally invert-emulsion systems, consisting of a continuous hydrocarbon phase and an emulsified aqueous phase. The fluid system is stabilized to meet the desired properties by addition of various chemicals such as emulsifiers, weighting agents, fluid-loss additives and viscosifiers. The effect of the water contamination in drilling slops is a lowering of the OWR, an increase in viscosity and a decrease in emulsion stability which ultimately renders the fluid unusable.

Accordingly, there exists a continuing need for methods of separating slop water to allow for reuse of the oleaginous phase in a wellbore fluid and discharge of an aqueous phase having purity levels sufficiently high to meet environmental regulations for discharge.

### SUMMARY OF THE DISCLOSURE

In one aspect, embodiments disclosed herein relate to a process for treating a recovered wellbore fluid, where the process includes contacting an aqueous wellbore fluid with ozone, wherein the aqueous wellbore fluid comprises organic contaminants; and separating the aqueous wellbore fluid into an organic phase and a clarified water phase.

In another aspect, embodiments disclosed herein relate to a process for treating a recovered wellbore fluid, wherein the process includes contacting the recovered wellbore fluid with a demulsifier; separating the recovered wellbore fluid into an oleaginous component and an aqueous component, wherein the aqueous component comprises organic contaminants; contacting the aqueous component with ozone; and separating the aqueous component into an organic phase and a clarified water phase.

Other aspects and advantages of the invention will be apparent from the following description and the appended claims.

### DETAILED DESCRIPTION

In one or more aspects, embodiments disclosed herein relate to methods for separating slop water into an oleaginous (or organic) phase and a clarified aqueous phase. Following the treatment process of the present disclosure, the resulting water phase may be clarified to a sufficiently high purity to meet local regulatory limits for discharge to the environment, particularly overboard discharge.

The recovered/separated slop water phase is contaminated with hydrocarbons and is treated using flocculation, filtration and centrifugation to meet or exceed local discharge consent limits, if possible. If it cannot be discharged, it must be sent for disposal.

Environmental regulations vary by the local governing authority and are the most stringent in Norwegian jurisdiction (i.e., less than 30 mg/L hydrocarbon in the discharge water). Following recovery of the mud phase from the slop, the separated water phase must still be cleaned to meet the stringent discharge requirements, or else the operator must pay for disposal.

Clarification of an aqueous phase (contaminated with organics) to such low hydrocarbon levels required for discharge into the environment may be achieved, in accordance with the present disclosure, by contacting the aqueous component of slop water with ozone. Following treatment with ozone, the fluid may be separated into an organic component and a clarified water phase.

As mentioned above, slop water generally contains about 10-50% by volume of an oleaginous fluid and 50-90% by volume of water (or other aqueous fluid) loosely emulsified therein. Depending on the amount of oleaginous fluid present in the slop water, an initial phase separation may be performed to separate the slop water into a substantially oleaginous fluid and a substantially aqueous fluid. If the phases are (at least somewhat) stabilized as an emulsion, a demulsifier may be used to destabilize the emulsion so that the two phases may be more readily separated from each other. However, there is some quantity of organic or oleaginous components that still contaminate the aqueous phase (and vice versa). The water-contamination is typically low enough that the separated oleaginous fluid may be reused as a wellbore fluid (such as an invert emulsion) upon the addition of any necessary fluid components (additives, water, etc.). However, the organic-contamination in the separated aqueous phase is generally too high for overboard discharge, for example. Thus, the ozone treatment is used to further destabilize the organics contaminants still emulsified in the aqueous fluid so that the organics may be removed therefrom, resulting in a clarified water phase. Without clarification, the aqueous fluid may be contaminated with hydrocarbons to such an extent that (at least some) regulatory limits for discharge are exceeded, requiring disposal instead of discharge. However, disposal is an unattractive option because of the considerable expense involved (particularly for large volumes) and the potential for environmental exposure.

As mentioned above, in accordance with the present disclosure, the aqueous component of contaminated wellbore fluids/slop water may be contacted with ozone. Ozone is known as an oxidizing agent, and will react with unsaturated compounds such as alkenes, unsaturated fatty acids, unsaturated esters and unsaturated surfactants. The present inventors have discovered that by contacting ozone with the aqueous component of slop water (contaminated with organics), a significant reduction in the hydrocarbon content of the aqueous component may result.

Without being bound to any particular mechanism, the present inventor believes that the methods disclosed herein operate through a chemical reaction known as ozonolysis. The reaction mechanism for a typical ozonolysis reaction involving an alkene is shown below:

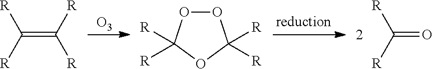

In the reaction, an ozone molecule (O₃) reacts with a carbon-carbon double bond to form an intermediate product known as ozonide. Hydrolysis of the ozonide results in the formation of carbonyl products (e.g., aldehydes and ketones). It is important to note that ozonide is an unstable, explosive compound and, therefore, care should be taken to avoid the accumulation of large deposits of ozonide. In addition, ozone may be decomposed in the aqueous phase by hydroxide ions present therein to produce another chemical oxidant, a hydroxyl radical, which has an even stronger electrochemical potential than ozone (2.8 V as compared to 2.08 V). Thus, the oxidation of the organic contaminants may occur by either molecular ozone or hydroxyl radicals, depending for example, on pH, temperature, organic loading, carbonate and bicarbonate concentrations.

Thus, it is thought that the carbonyl products formed via ozonolysis and/or other products formed by hydroxyl radical oxidation of the hydrocarbons may “loosen” the emulsion and, as a result, the emulsion may separate into its constituent organic and clarified water phases. Therefore, in embodiments disclosed herein, ozone effects separation of the aqueous phase into an organic phase and a clarified water phase by reacting with the emulsified hydrocarbons in the aqueous component.

Embodiments of the present disclosure involve contacting the aqueous component of slop water with an effective amount of ozone. An “effective amount,” as the term is used herein, refers to an amount sufficient to separate the aqueous component into an organic phase and a clarified water phase. One of ordinary skill in the art would appreciate that the effective amount is a function of the concentration of the organic contaminants and the volume of the aqueous component to be treated. Further, the effective amount of ozone may also be a function of time. In some embodiments disclosed herein, the effective amount of ozone may range from about 100 ppm to about 3,500 ppm ozone per gram of aqueous component. However, one skilled in the art would appreciate that, in other embodiments, more or less ozone may be used depending on the contamination level and the volume to be treated.

In a particular embodiment, ozone may be generated as a result of electrical discharge from a corona discharge element, which causes an oxygen molecule to split and form two oxygen radicals. The radicals may then be combined with oxygen molecules to form ozone. A generator may be capable of producing an ozone concentration of 0 to 100 percent depending on the voltage applied to the corona tube. Compressed oxygen having a dew point of −60° F. (−51° C.) may be used as the feed gas to prevent simultaneous formation of nitrogen oxide compounds from water vapor. The generated ozone may then be sparged into a volume of slop water, optionally with a diffuser attached to the end of the sparge tube.

Following treatment with the ozone, substantially aqueous component may be allowed to separate (i.e., by oil-water separation) into two phases, i.e., a clarified water phase and an organic contaminant phase. Further, it is likely that the composition of the organic contaminant phase separated from the clarified water phase is such that disposal is most likely necessary (due to the likely presence of aldehydes and ketones). However, if the composition permits, this organic phase may be reused in a drilling or completion process. Additionally, the clarified water phase may be tested to determine the hydrocarbon content to ensure that it is within the discharge limit required by the local jurisdiction (e.g., the regulations in the North Sea are 30 mg/L and 40 mg/L for the Gulf Coast). Such hydrocarbon contents may be determined using any known method. Currently, OSPAR recommends a reference method involving gas chromatography (GC) and flame ionization detection (FID), described in ISO 9377-2 GC-FID method for measuring oil in water (OiW). Another method is EPA Method 8015B. Both methods involve hexane/DCM extraction and GC-FID analysis after SiO₂/Fluorosil extraction. In accordance with embodiments of the present disclosure, the clarified water phase produced by the treatment methods disclosed herein may have a hydrocarbon content of less than 40 mg/L and less than 30 mg/L in a more particular embodiment.

Prior to discharge, the clarified water phase may be treated with activated carbon, silica gel or other similar adsorbent material to remove any residual polar compounds present therein prior to discharge. Generally, these materials may serve to pull the remaining contaminants to the adsorbent's surface and then into the porous structure of the adsorbent material by van der Waals forces.

Further, as mentioned above, the substantially aqueous phase (having organic contaminants therein) may be the result of a more heavily contaminated fluid having first being separated into a substantially aqueous phase and a substantially oleaginous phase. Oftentimes, slop water that results from a drilling process will have emulsifiers therein, i.e., preventing the separation of the two phases from each other due to the emulsification/stabilization of one phase within the other. Thus, depending on the emulsion of one phase within another, a demulsifier may be used to better allow for phase separation. Specifically, demulsifiers are surface active agents (having both hydrophilic and hydrophobic components) that act to destabilize an emulsion and separate an emulsified fluid its constituent oleaginous and non-oleaginous phases. Upon treatment of slop water with a demulsifier, the fluid may be allowed to separate into the substantially aqueous phase and substantially oleaginous phase, such as by an oil-water separation. Suitable examples of such demulsifiers include alkyl polyglycosides and alcohol ethoxylates.

Alkyl polyglycosides are commercially available substances produced by the acid-catalyzed reaction of glycosides and fatty alcohols. Alkyl polyglycosides are used in the personal body care and food industries and are environmentally friendly. The alkyl polyglycosides used in embodiments disclosed herein have the formula:

R₁—O—Gₙ

where R₁ is a linear or branched, saturated or unsaturated C₁ to C₂₂ alkyl radical, G is a glycose unit, and n is a number from 1 to 10.

The alcohol ethoxylates used in the embodiments disclosed herein have the formula:

R₂—O—(EO)ₘH

where R₂ is a linear or branched, saturated or unsaturated C₁ to C₂₂ alcohol, EO is an ethylene oxide radical, and m is a number from 1 to 5. In some embodiments disclosed herein, the alcohol ethoxylate is 2-ethylhexanol ethoxylate.

Thus, in some embodiments disclosed herein, a demulsifier may be used to separate slop water into an oleaginous component and an aqueous component (containing some level of organic contaminants). Use of a demulsifier may result in a lower level of organic contaminants present in the aqueous component; however, additional clarification with an ozone treatment, as discussed above, is still necessary to result in a clarified water phase that meets regulatory requirements for discharge. Thus, a demulsifier may be added to slop water, and then the slop water may be physically separated into a substantially oleaginous phase and a substantially aqueous fluid, as described above. Following demulsification and separation, the substantially aqueous fluid may then be treated with ozone.

However, the oleaginous fluid separated from the slop water may be reused as a wellbore fluid. Wellbore fluids of the present disclosure may include emulsions of an oleaginous liquid and a non-oleaginous liquid (or an oleaginous fluid alone). As used herein, the term “oleaginous liquid” refers to an oil which is a liquid at 25° C. and immiscible with water. Oleaginous liquids typically include substances such as diesel oil, mineral oil, synthetic oil, ester oils, glycerides of fatty acids, aliphatic esters, aliphatic ethers, aliphatic acetals, other hydrocarbons, and combinations thereof.

As used herein, the term “non-oleaginous liquid” refers to any substance which is a liquid at 25° C. and not an oleaginous liquid as defined above. Non-oleaginous liquids are immiscible with oleaginous liquids but are capable of forming emulsions therewith. Typical non-oleaginous liquids include aqueous substances such as fresh water, sea water, brine, aqueous solutions containing water-miscible organic compounds, and mixtures thereof. Thus, upon separation of the oleaginous component from the slop water, it may be combined with a non-oleaginous phase (to the desired oil-water ratio instead of water-heavy ratio of the slop water) as well as various wellbore fluid additives known in the art of wellbore fluid formation.

Further, to accelerate separation of the clarified water phase and the organic contaminants phase following the ozone treatment, it may also be desirable to adjust the pH of the organic-contaminated aqueous component during the ozone treatment. For example, the pH of the aqueous component may be adjusted to between 7 and 10, and between 7 and 8 in a particular embodiment.

Additionally, in some embodiments disclosed herein, in addition to pH adjustment, a flocculent and/or a coagulant may also or alternatively be added to the aqueous component to accelerate separation of the organic contaminants phase and the clarified water phase. Flocculants and coagulants aggregate the emulsified phase and thereby accelerate separation of the aqueous component into an organic phase and a clarified water phase.

The stability of an emulsion for a liquid-liquid dispersion is determined by the behavior of the surface of the particle via its surface charge and short-range attractive van der Waals forces. Electrostatic repulsion prevents dispersed particles (emulsed phase) from combining into their most thermodynamically stable state of aggregation into the macroscopic form, thus rendering the dispersions metastable. Emulsions are metastable systems for which phase separation of the oil and water phases represents to the most stable thermodynamic state due to the addition of a surfactant to reduce the interfacial energy between oil and water.

Oil-in-water emulsions are typically stabilized by both electrostatic stabilization (electric double layer between the two phases) and steric stabilization (van der Waals repulsive forces), whereas invert emulsions (water-in-oil) are typically stabilized by only steric stabilization. Coagulation occurs when the electrostatic charge on a colloidal dispersion (emulsion for a liquid-liquid dispersion) is reduced, destabilizing the emulsion and allowing it to be attracted to other solids by van der Waals forces. However, coagulation is an aggregation of particles (or emulsed phases) on a microscopic level. Flocculation is the binding of individual particles (or emulsed phases) into aggregates of multiple particles on a macroscopic. Flocculation is physical, rather than electrical, and occurs when one segment of a flocculating polymer chain absorbs simultaneously onto more than one particle.

Thus, to achieve the precipitation and aggregation of the finely dispersed oleaginous phase in the organic contaminated aqueous fluid (so that physical or mechanical separation of the organic contaminants from the fluid may occur), a flocculant may be added to the fluid. Flocculants suitable for use in the present disclosure may include for example, high molecular weight (2,000,000-20,000,000) acrylic acid or acrylate-based polymers. The charge density of the polymers may range from 0-100 percent (in either charge direction). In a particular embodiment, the charge density may range from 0-80 percent. Thus, depending on the charges of the monomers, the resulting polymers may be cationic, anionic, or non-ionic.

In addition to a flocculant, a coagulant may be used to assist in aggregating colloidal particles within a fluid. The coagulant may be an inorganic or polyelectrolyte type. Most inorganic coagulants will also reduce the pH due to the inherent acidity of the salt. If further use in downhole operations, such as drilling, of the clarified water is desired, a polyelectrolyte coagulant may be selected so that the pH of the fluid does not substantially change. However, if discharge of the fluid is desired, an acidic inorganic coagulant may be selected to reduce the pH of the fluid, and trigger coagulation and flocculation of the dispersed organics within the fluid.

Examples of inorganic coagulants include aluminum- and iron-based coagulants, such as aluminum chloride, poly(aluminum hydroxy)chloride, aluminum sulfate, ferric sulfate, ferric chloride, etc. Further, one of ordinary skill in the art would appreciate that selection of the coagulant may depend, for example, on the pH of the fluid, presence of ions in the fluid, requirements for the final fluid, etc. One examples of an inorganic coagulants includes poly(aluminum hydroxy)chlorides.

Examples of polyelectrolyte coagulants include water-soluble organic polymers that may be cationic, anionic, or non-ionic. In a particular embodiment, cationic polymers having molecular weights generally less than 500,000 may be used. However, higher molecular weight polymers (such as up to 20,000,000) may be used in yet other embodiments. The charge density of the polymers may range up to 100 percent. Cationic monomers may include diallyl dialkyl ammonium halides and dialkylaminoalkyl(meth)-acrylates and -acrylamides, (as acid addition or quaternary ammonium salts). In a particular embodiment, the coagulant may include poly diallyl dimethyl ammonium chloride.

### EXAMPLES

The following examples are provided to further illustrate the application and use of the methods disclosed herein for treating recovered wellbore fluids.

### Example 1

A water-contaminated NOVAPLUS™ invert emulsion wellbore fluid (having base fluid as Internal Olefin C16 to C18), i.e., slop water, containing 50 vol % added water and 50 vol % synthetic based mud, was tested. was prepared in the laboratory under low shear conditions employing the Hamilton beach mixer for several minutes. A significant amount of shear and mixing energy is required to emulsify contaminant water into an invert drilling fluid to produce slop. A 500 mL sample of the contaminated fluid/slop water was contacted with a glycoside demulsifier EMR-953 at 2 vol % (available from M-I L.L.C. (Houston, Tex.), and allowed to be dispersed therein using the Hamilton beach mixer for 30 seconds. The fluid was allowed to phase separate into an oleaginous component and an aqueous component in a separation funnel. The separated aqueous phase was filtered using a 54 Whitman filter paper (20-25 micron) to remove solids dispersed therein. The aqueous component had a Total Petroleum Hydrocarbons (“TPH”) or Oil in Water (OiW) of 4,103 mg/L as determined by GC/FID after SiO₂ extraction, measured according to EPA method 8015 B.

The aqueous component was contacted with 1.63 gm of ozone and allowed to separate into phases in a separation funnel. Separation into an organic phase and a clarified water phase required 45 minutes. The clarified water phase had an OiW of 30 mg/L as determined by GC/FID after SiO₂ extraction. Ozone treatment of the aqueous component of the slop water reduced TPH by 99%.

### Example 2

A 500 mL sample of filtered slop water produced as from Example 1 was used in this example. The pH of the filtered slop separated water sample was reduced to 9 from 12 by addition of 35% hydrochloric acid before ozonation. Addition of 0.5 gm of ozone was sparged at a flow rate of 1 L/min into the 500 mL sample. The pH of the water sample remained steady at 9 but the color of the sample changed from greenish yellow to a white turbid color during the 10 minute ozonation test run. The ozonated water was transferred to a 500 mL separatory funnel, and the liquid was allowed to settle. After two hours of settling, a yellow colored top phase was observed in the funnel, and after overnight settling, the top phase increased in thickness and was milky in color. The bottom phase was observed to be clarified, i.e., a clear, colorless liquid. The top and bottom phases were sampled for OiW analysis. The OiW of the slop separated filtered water before treatment with ozone and phase separation was measured to be 2,068 mg/L. The OiW of the bottom phase after ozone treatment and phase separation was measured to be 38 mg/L. The OiW of the top phase after ozone treatment and phase separation was measured to be 12,690 mg/L. The GC-FID analysis of the top phase showed peaks of Internal Olefin C16 to C18, alkyl glucoside and aldehydes/ketones.

### Example 3

A 500 mL sample of the filtered slop water produced as from Example 1 was used in this example. The pH of the filtered slop separated water sample was reduced to 8 from 12 by addition of 35% hydrochloric acid before ozonation. Addition of 0.48 gm of ozone was sparged at a flow rate of 1 L/min into the 500 mL sample. The pH of the water sample decreased slightly from 8.0 to 7.5. The color of the sample changed from greenish yellow to a milky color during the 10 minute ozonation test run. After overnight settling in a 1000 mL separatory funnel, the top phase did not increase in thickness and was yellowish in color. The bottom phase was sampled for OiW analysis. The OiW of the bottom phase after ozone treatment and phase separation was measured to be 22 mg/L. GC-FID analysis of showed peaks of Internal Olefin C16 to C18, alkyl glucoside and aldehydes/ketones similar to Example 2.

### Example 4

A 500 mL sample of filtered slop water produced as from Example 1 was used in this example. The pH of the filtered slop separated water sample was reduced to 7 from 12 by addition of 35% hydrochloric acid before ozonation. Addition of 0.75 gm of ozone was sparged at a flow rate of 1 L/min into the 500 mL sample. The pH of the water sample decreased slightly from 7.0 to 6.7. The color of the sample changed from greenish yellow to a milky color during the 15 minute ozonation test run. The bottom phase was sampled for OiW analysis. The OiW of the slop separated filtered water before treatment with ozone and phase separation was measured to be 2,068 mg/L. The OiW of the bottom phase after ozone treatment and phase separation was measured to be 19 mg/L. The OiW of the top phase after ozone treatment and phase separation was not measured but the GC-FID analysis showed peaks of Internal Olefin C16 to C18, alkyl glucoside and aldehydes/ketones similar to Example 3.

### Comparative Example

A water-contaminated (50:50) NOVAPLUS™ invert emulsion wellbore fluid, i.e., slop water, was obtained. The sample was contacted with 2% glycoside demulsifier EMR-953 (available from M-I L.L.C. (Houston, Tex.)) and allowed to phase separate into an oleaginous component and an aqueous component in a separation funnel. Into 300 mL of slop separated water, 1.5 mL of 10% caustic in deionized water, 6 g/L Wigofloc AFF and 0.9 vol. % were added and the sample was allowed to settle. No settling occurred after 30 min, and the sample was still hazy after a day with light sediment and no oil on top. The OiW of the slop separated water before treatment with flocculants and coagulants was measured to be 3,109 mg/L. The OiW of the sample after treatment with flocculants and coagulants was measured to be 2,920 mg/L.

A summary of the OiW contents before and after treatments for the Examples 1-4 and Comparative Example is shown in Table 1 below. As evident from this table, the use of coagulants and flocculants, which are often used in water/oil separations, result in minimal reduction of OiW content, particularly as compared to the ozone treatments in Examples 1-4, all of which resulted in over 98 or 99% reduction in hydrocarbon content.

TABLE 1

| | Before | | After Flocculants |
|---|---|---|---|
| | Treatment | After Ozone | and Coagulants |
| Example 1 | 4,103 mg/L | 30 mg/L | — |
| Example 2 | 2,068 mg/L | 38 mg/L | — |
| Example 3 | 2,068 mg/L | 22 mg/L | — |
| Example 4 | 2,068 mg/L | 19 mg/L | — |
| Comparative Example | 3,109 mg/L | — | 2,920 mg/L |

Advantageously, embodiments disclosed herein may provide a process for treating the aqueous component of a water-contaminated wellbore fluid. In particular, embodiments disclosed herein may provide a process for reducing the amount of hydrocarbon contaminants in the aqueous component. Additionally, embodiments disclosed herein may reduce the need for make-up wellbore fluids and reduce the cost of slop water disposal.

While the disclosure includes a limited number of embodiments, those skilled in the art, having benefit of this disclosure, will appreciate that other embodiments may be devised which do not depart from the scope of the present disclosure. Accordingly, the scope should be limited only by the attached claims.

What is claimed:

1. A process for treating a recovered wellbore fluid, the process comprising:
contacting an aqueous wellbore fluid with ozone, wherein the aqueous wellbore fluid comprises organic contaminants; and
separating the aqueous wellbore fluid into an organic phase and a clarified water phase.

2. The process of claim 1, wherein a concentration of ozone in the aqueous wellbore fluid is in the range from about 100 to about 3,500 ppm ozone per gram of aqueous wellbore fluid.

3. The process of claim 1, further comprising:
adjusting the pH of the aqueous wellbore fluid.

4. The process of claim 3, wherein the adjusted pH of the aqueous wellbore fluid ranges between about 7 and 10.

5. The process of claim 3, wherein the adjusted pH of the aqueous wellbore fluid ranges between about 7 and 8.

6. The process of claim 1, further comprising:
disposing of the organic phase.

7. The process of claim 1, further comprising:
discharging the clarified water phase.

8. The process of claim 1, wherein the clarified water phase has a hydrocarbon content of less than 40 mg/L.

9. A process for treating a recovered wellbore fluid, the process comprising:
contacting the recovered wellbore fluid with a demulsifier;
separating the recovered wellbore fluid into an oleaginous component and an aqueous component, wherein the aqueous component comprises organic contaminants;
contacting the aqueous component with ozone; and
separating the aqueous component into an organic phase and a clarified water phase.

10. The process of claim 9, wherein the demulsifier comprises at least one of an alkyl polyglycoside and an alcohol ethoxylate.

11. The process of claim 10, wherein the alkyl polyglycoside has the formula
R₁—O—Gₙ
where R₁ is a linear or branched, saturated or unsaturated C₁ to C₂₂ alkyl radical, G is a glycose unit, and n is a number from 1 to 10.

12. The process of claim 10, wherein the alcohol ethoxylate has the formula
R₂—O—(EO)ₘH
where R₂ is a linear or branched, saturated or unsaturated C₁ to C₂₂ alcohol, EO is an ethylene oxide radical, and m is a number from 1 to 5.

13. The process of claim 11, wherein the alcohol ethoxylate is 2-ethylhexanol ethoxylate.

14. The process of claim 9, further comprising:
recycling the oleaginous component as a wellbore fluid.

15. The process of claim 9, wherein a concentration of ozone in the aqueous component is in the range from about 100 to about 3,500 ppm ozone per gram of aqueous component.

16. The process of claim 9, further comprising:
adjusting the pH of the aqueous component.

17. The process of claim 9, further comprising:
adding at least one of a flocculant and a coagulant to accelerate the separation of the aqueous component into the organic phase and the clarified water phase.

18. The process of claim 9, further comprising:
disposing of the organic phase.

19. The process of claim 9, further comprising:
discharging the clarified water phase.

20. The process of claim 9, wherein the clarified water phase has a hydrocarbon content of less than 40 mg/L.

21. The process of claim 20, wherein the clarified water phase has a hydrocarbon content of less than 30 mg/L.
